(19) United States
(12) Patent Application Publication
(10) Pub. No.: US 2026/0352247 A1
(43) Pub. Date: Nov. 5, 2026

(54) RADIO HOLSTER WITH CONTROL SHIELDING

(71) Applicant: Eighty-O-Eight Products, LLC, Spokane, WA (US)

(72) Inventor: Randy Tyler Watts, Spokane, WA (US)

(73) Assignee: Eighty-O-Eight Products, LLC, Spokane, WA (US)

(21) Appl. No.: 19/664,395

(22) Filed: Apr. 30, 2026

Related U.S. Application Data
(60) Provisional application No. 63/799,928, filed on May 5, 2025.

(51) Int. Cl. H04B 1/3888; H04M 1/04

(52) U.S. Cl. CPC H04B 1/3888; H04M 1/04

(57) ABSTRACT

In various examples, a radio holster may prevent unintentional activation, deactivation, and adjustment of radio controls through integrated shielding and retention features. For instance, the radio holster may include a body configured to receive and retain a radio and a shielding portion extending upward from the body along at least one side of the radio. The shielding portion may be positioned to at least partially cover control interfaces of the radio, such as volume control knobs, squelch control knobs, channel selectors, and push-to-talk buttons, to prevent inadvertent adjustment while allowing intentional operation. The shielding portion may extend in a direction substantially parallel to a longitudinal axis associated with the radio to create a continuous protective structure around top-mounted controls and side-mounted controls. A retention mechanism may secure the radio within the body to minimize movement and prevent displacement.

### CROSS-REFERENCE TO RELATED APPLICATIONS

This application claims priority to U.S. Provisional Application No. 63/799,928, filed on May. 5, 2025, which is hereby incorporated by reference in its entirety.

### BACKGROUND

Holsters may be used to secure various devices, such as radios, firearms, tools, or other equipment, allowing users to carry and access items efficiently. For example, holsters may be used by military personnel, law enforcement officers, emergency responders, and general civilians to help ensure that devices remain protected and readily available for operation. In various instances, holsters may be designed to attach to a belt, vest, or other gear, providing stability while allowing quick retrieval when needed.

Portable radios, in particular, are commonly carried by professionals who rely on consistent and reliable communication in demanding environments. These radios often include various control interfaces, such as volume control knobs, squelch control knobs, channel selectors, push-to-talk buttons, and other adjustment mechanisms. Maintaining proper settings on these controls may be important for effective communication, as unintended changes to volume levels, channel selections, or other parameters could disrupt operations or cause missed transmissions.

However, conventional holsters may not always prevent unintentional interaction with the secured device. Accidental activation, deactivation, or adjustment of controls may occur not only when retrieving or storing the device but also during routine movements or activities. For instance, a user may inadvertently bump or press against the device while entering or exiting a vehicle, navigating confined spaces, or engaging in physical tasks. While some holster designs may incorporate protective features or retention mechanisms, they may not consistently safeguard against unintended interactions while maintaining ease of access.

### SUMMARY

Embodiments of the present disclosure relate to a radio holster with control shielding. In various examples, the radio holster may prevent unintentional activation, deactivation, and adjustment of radio controls through integrated shielding and retention features.

In accordance with one or more embodiments of the present disclosure, a radio holster may include a body configured to receive and retain a radio and a shielding portion extending upward from the body along at least one side of the radio. The shielding portion may be positioned to at least partially cover control interfaces of the radio, such as volume control knobs, squelch control knobs, channel selectors, and push-to-talk buttons, to prevent inadvertent adjustment while allowing intentional operation. The shielding portion may extend in a direction substantially parallel to a longitudinal axis associated with the radio to create a continuous protective structure around top-mounted controls and side-mounted controls. A retention mechanism may secure the radio within the body to minimize movement and prevent displacement.

In contrast to conventional systems, the radio holster systems described herein may be able to provide integrated shielding that forms a continuous protective structure around both top-mounted and side-mounted control interfaces, reducing the likelihood of inadvertent activation or adjustment during routine activities, physical movement, or external impacts. Additionally, the radio holster systems described herein may incorporate configurable retention mechanisms that allow for different retention level classifications while maintaining accessibility for intentional operation. The combination of shielding and retention features may provide enhanced protection for radio controls compared to conventional holster designs that may lack comprehensive coverage of control interfaces or may not adequately prevent unintended interactions during demanding operational conditions.

### BRIEF DESCRIPTION OF FIGURES

Non-limiting and non-exhaustive examples are described with reference to the following figures.

FIG. 1 illustrates a perspective view of a radio holster, according to aspects of the present disclosure.

FIG. 2A illustrates a side view of the radio holster of FIG. 1, according to aspects of the present disclosure.

FIG. 2B illustrates a frontal view of the radio holster of FIG. 1, according to aspects of the present disclosure.

FIG. 2C illustrates another side view of the radio holster of FIG. 1, according to aspects of the present disclosure.

FIG. 3 illustrates a perspective view of the radio holster securing a radio, according to aspects of the present disclosure.

FIG. 4 illustrates a top-down view of the radio holster securing a radio, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to radio holsters having integrated features for preventing unintentional activation, deactivation, and adjustment of radio controls. A radio holster may include structural elements or protective features that limit accidental contact with control interfaces, such as volume controls, squelch controls, push-to-talk buttons, channel selectors, and other control interfaces of a radio. In some cases, these structural elements and features may be configured to provide physical shielding from unintentional interaction, while still allowing intentional operation. Additionally, a radio holster may incorporate retention mechanisms or positioning elements that help secure a radio in a manner that reduces exposure to inadvertent adjustments caused by movement, external impacts, and routine handling.

In various examples, a radio holster may be configured to enclose or shield one or more specific portions of a radio to provide physical protection while maintaining accessibility where needed. For instance, a radio holster may partially or fully enclose portions of a radio to form a protective barrier against accidental contact with certain components of the radio. Additionally, in some examples, a radio holster may include selectively positioned openings to expose functional components of a radio, such as a speaker and microphone, ensuring that audio transmission and reception remain unaffected while the radio is holstered.

In some instances, a radio holster may include portions that cover or shield control interfaces of a radio such as volume control knobs, squelch control knobs, channel selectors, push-to-talk buttons, or other adjustment mechanisms. For example, a radio holster may include a shielding portion that extends in a direction substantially parallel to a longitudinal axis associated with the radio to create a continuous protective structure around top-mounted controls and side-mounted controls, reducing the likelihood of inadvertent activation. Additionally, or alternatively, a radio holster may include recessed areas or selectively positioned cutouts to allow controlled access to one or more control interfaces while shielding others from unintentional operation.

A radio holster may, in some examples, include a retention mechanism to secure a radio within the holster. In some examples, a retention mechanism may include a retention clip to hold a radio in place within the holster and prevent vertical displacement while still allowing intentional removal. Additionally, or alternatively, a strap, latch, or other securing feature may be included to achieve similar functionality or achieve an additional layer of retention. A radio holster may be configured to provide firm engagement with a radio to minimize movement that could otherwise lead to displacement of the radio from the holster or unintended adjustment or activation.

In some examples, a radio holster may be constructed from a variety of materials, including polymers, composites, metals, or other materials or combinations thereof. Additionally, a radio holster may be manufactured using various techniques, such as injection molding, machining, thermoforming, additive manufacturing, or other manufacturing techniques. In some instances, a radio holster may be designed to accommodate one or more specific radio models, providing a secure and precise fit while incorporating structural features that mitigate unintentional interaction with control interfaces. A radio holster may also be designed for different carrying configurations, including belt-mounted, chest-mounted, shoulder-mounted, or integration with MOLLE-compatible systems.

A radio holster may, in various embodiments, be configured to provide different levels of retention, allowing the holster to meet various retention level classifications or standards, such as Level 1, Level 2, or Level 3 retention classifications. For instance, a radio holster may be modified to include various different types of retention mechanisms, such as the addition of active or passive locking features, enhanced friction fit designs, or multiple retention points, to achieve a desired level of security while still allowing intentional access to a radio. Level 1 holsters may refer to holsters that use basic retention mechanisms, often relying on the fit of the retained object within the holster for retention, which may include friction or a passive retention system. Level 1 holsters may offer quick and easy access to the retained object and may be suitable for situations where speed is desired. Level 2 holsters may refer to holsters that incorporate a secondary retention feature, such as a thumb break, snap, or clip, in addition to the passive retention of Level 1 holsters. Level 2 holsters may offer slightly slower draw times compared to Level 1 due to the need to disengage the secondary retention mechanism. Level 3 holsters may refer to holsters that feature multiple retention mechanisms, such as a thumb lock and an additional strap, that may be disengaged before drawing the object. Level 3 holsters may be slower to access than Level 1 and Level 2 due to the extra steps that may be required to draw the object from the holster.

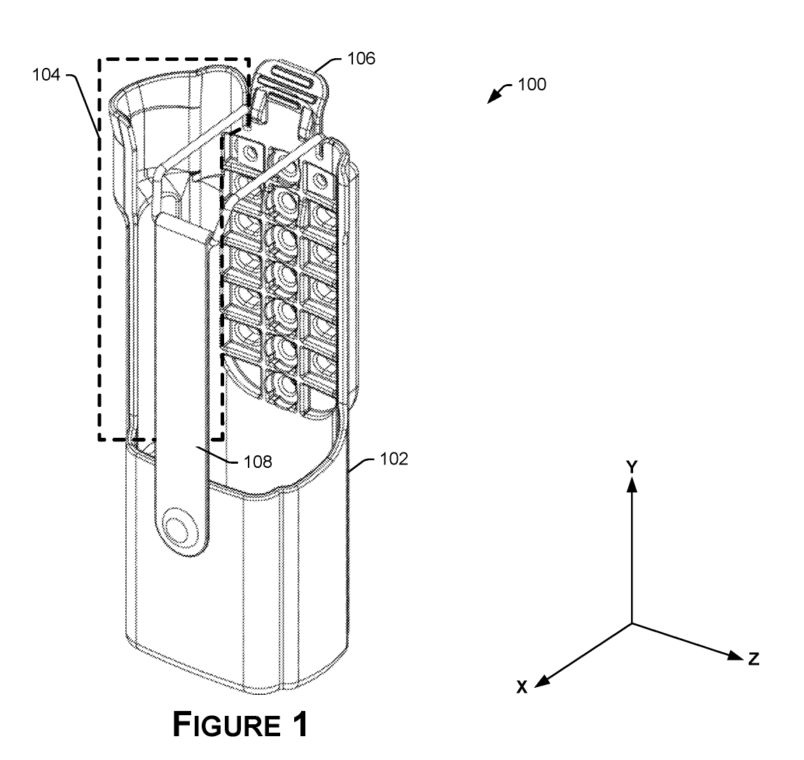

FIG. 1 illustrates a perspective view of a radio holster 100, in accordance with some embodiments of the present disclosure. The radio holster 100 may include a body 102, a shielding portion 104, a retention clip 106, and a retention strap 108. The body 102 may be configured to receive and retain a radio, providing structural support and housing for the radio when holstered. The shielding portion 104 may be attached to the body 102 and may extend from a bottom portion and a back portion of the body 102 to cover or shield control interfaces of a radio, such as volume control knobs, squelch control knobs, channel selectors, push-to-talk buttons, or other interface controls. In some cases, the shielding portion 104 may extend in a direction substantially parallel to an axis Y to create a continuous protective structure around top-mounted controls and side-mounted controls, reducing the likelihood of inadvertent activation.

The retention clip 106 may be positioned at a top portion of the radio holster 100 and may be configured to hold a radio in place within the radio holster 100 and prevent vertical displacement while still allowing intentional removal. The retention strap 108 may extend across a front portion of the body 102 and may provide an additional layer of retention to secure a radio within the radio holster 100.

In some examples, the radio holster 100 may be constructed from a variety of materials, including polymers, composites, metals, or other materials or combinations thereof. Additionally, the radio holster 100 may be manufactured using various techniques, such as injection molding, machining, thermoforming, additive manufacturing, or other manufacturing techniques. In some instances, the radio holster 100 may be designed to accommodate one or more specific radio models, providing a secure and precise fit while incorporating structural features that mitigate unintentional interaction with control interfaces. The radio holster 100 may also be designed for different carrying configurations, including belt-mounted, chest-mounted, shoulder-mounted, or integration with MOLLE-compatible systems.

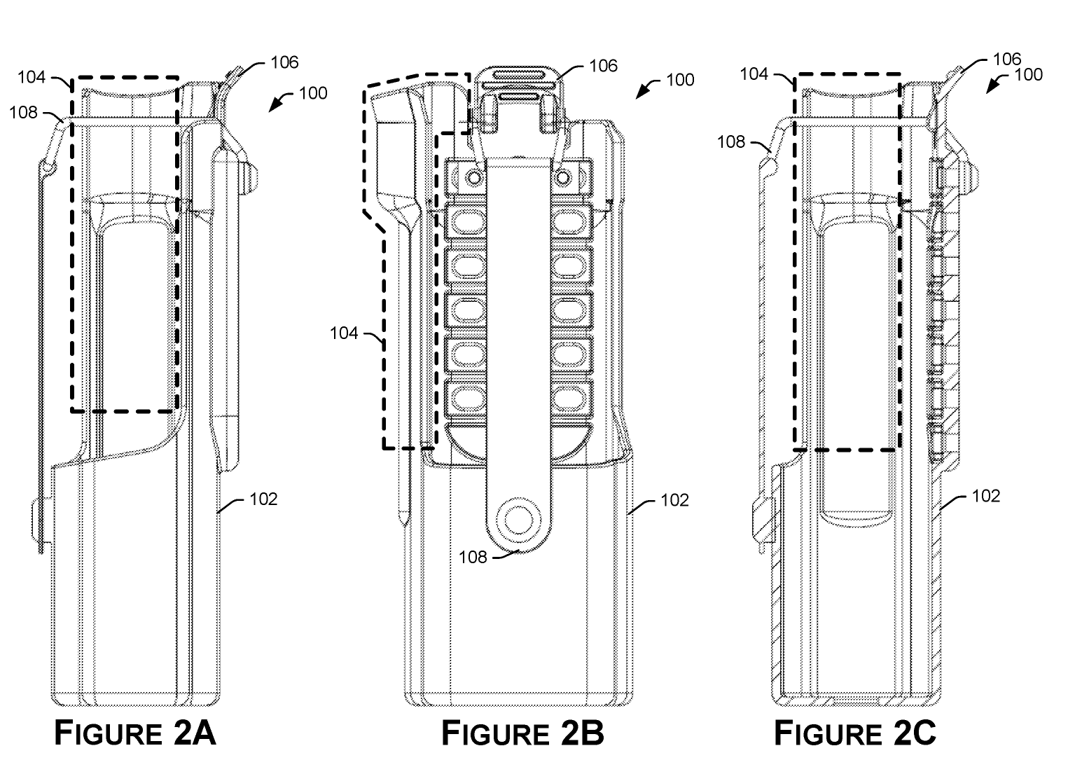

FIGS. 2A-2C illustrate additional views of the radio holster 100, in accordance with some embodiments of the present disclosure. FIG. 2A illustrates a side view of the radio holster 100, FIG. 2B illustrates a frontal view of the radio holster 100, and FIG. 2C illustrates another side view of the radio holster 100.

As shown in FIGS. 2A-2C, the shielding portion 104 extends from a bottom portion of the body 102 and a back portion of the body 102 to cover or shield control interfaces of a radio when retained within the radio holster 100. The shielding portion 104 is indicated by dashed lines in each view, showing the protective structure that covers or shields control interfaces such as volume control knobs, squelch control knobs, channel selectors, push-to-talk buttons, or other interface controls.

In some examples, the body 102 may include recessed areas or selectively positioned cutouts to allow controlled access to one or more input interfaces while shielding others from unintentional operation. For instance, the radio holster 100 may include a cutout in the body 102 around a push-to-talk button so the functionality of the push-to-talk button may be maintained while a radio is holstered. In some cases, the cutout may be positioned to expose the push-to-talk button while the shielding portion 104 continues to shield other side-mounted controls or top-mounted controls from unintentional contact.

Additionally, the body 102 may include selectively positioned openings to expose functional components of a radio, such as a speaker and a microphone. The openings may be positioned to correspond to speaker and microphone locations of a radio, ensuring that audio transmission and reception remain unaffected while the radio is retained in the radio holster 100. In some examples, the openings may be located at a front portion of the body 102 to align with audio components of a radio when the radio is holstered.

The retention clip 106 is positioned at a top portion of the radio holster 100 and is configured to engage with a radio to secure the radio within the radio holster 100. The retention strap 108 is shown extending across a portion of the body 102 to provide an additional layer of retention.

The shielding portion 104 may extend upward from a base portion of a radio holster in a direction substantially parallel to a longitudinal axis passing through a radio from top to bottom. In some cases, the shielding portion 104 may extend along at least one side of a radio to create a continuous protective structure around top-mounted controls and side-mounted controls, reducing the likelihood of inadvertent activation. For instance, the shielding portion 104 may at least partially cover control interfaces such as volume control knobs, squelch control knobs, channel selectors, or other top-mounted controls of a radio when the radio is retained within a radio holster.

In some examples, the shielding portion 104 may conceal one or more side-mounted controls of a radio, such as a push-to-talk button. Because the shielding portion 104 extends upward substantially parallel to the longitudinal axis of a radio, the shielding portion 104 may provide a physical barrier that obstructs unintentional contact with side-mounted controls while a radio is holstered. In some cases, the shielding portion 104 may extend along both sides of a radio to provide protection for side-mounted controls on multiple sides.

The shielding portion 104 may extend to various heights relative to a volume knob or other top-mounted control of a radio. In some examples, the shielding portion 104 may extend above the volume knob, forming a barrier that surrounds the volume knob and prevents accidental contact from above. In other examples, the shielding portion 104 may extend flush with the volume knob, providing lateral protection while allowing access from directly above. In still other examples, the shielding portion 104 may extend below flush with the volume knob, providing partial shielding while maintaining greater accessibility to the volume knob. The height of the shielding portion 104 relative to the volume knob may be selected based on a desired balance between protection and accessibility for a particular application or radio model.

The radio holster 100 may be configured to provide different retention level classifications based on the inclusion or exclusion of retention mechanisms. In some examples, the radio holster 100 may not include either of the retention clip 106 or the retention strap 108 and may be classified as a Level 1 holster. Level 1 configurations may rely on the fit of a radio within the radio holster 100 for retention, which may include friction or a passive retention system. In some examples, the radio holster 100 may include only the retention clip 106 and may be classified as a Level 2 holster. Level 2 configurations may incorporate the retention clip 106 as a secondary retention feature in addition to passive retention. In some examples, the radio holster 100 may include both the retention clip 106 and the retention strap 108 and may be classified as a Level 3 holster. Level 3 configurations may feature multiple retention mechanisms that may be disengaged before removing a radio from the radio holster 100.

The radio holster 100 may be configured to provide firm engagement with a radio to minimize movement that could otherwise lead to displacement of the radio from the radio holster 100 or unintended adjustment or activation. The retention strap 108 may be included to achieve similar functionality to the retention clip 106 or to achieve an additional layer of retention. In some cases, the retention strap 108 may extend across a portion of a radio to provide supplemental securing force in addition to the retention clip 106. The combination of the retention clip 106 and the retention strap 108 may reduce the likelihood of a radio becoming dislodged during physical activity, movement, or external impacts.

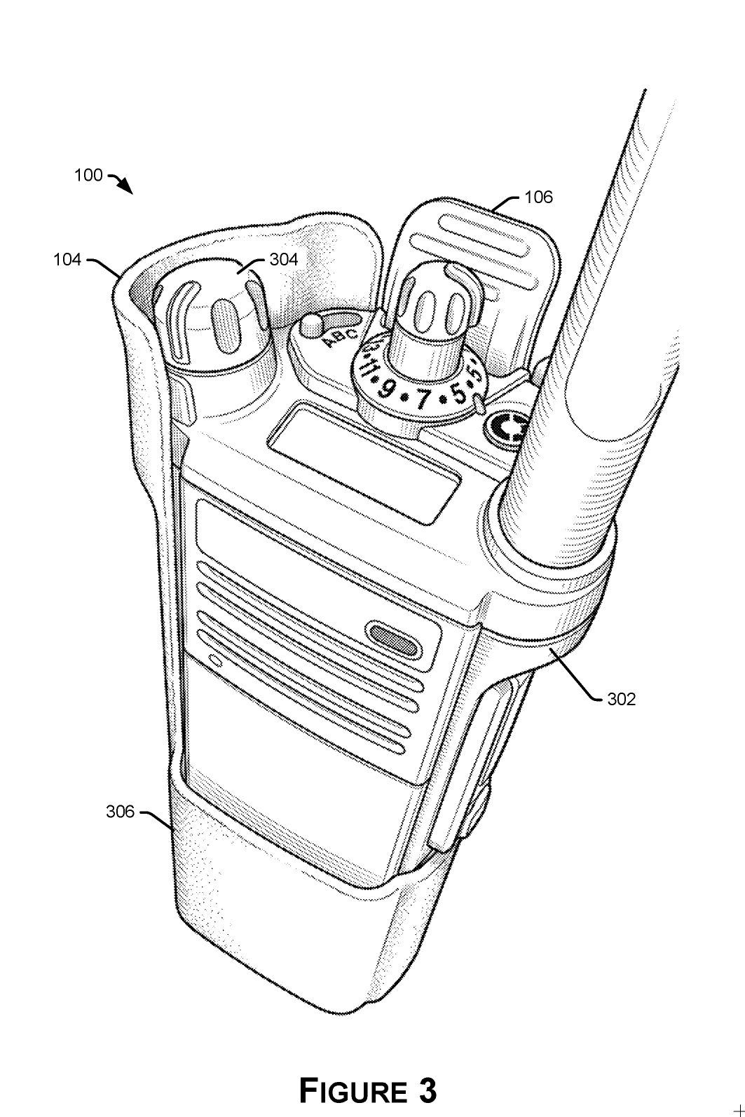

FIG. 3 illustrates a perspective view of the radio holster 100 securing a radio 302, in accordance with some embodiments of the present disclosure. The radio 302 may include a volume knob 304 positioned on a top portion of the radio 302, as well as additional top-mounted controls and side-mounted controls. When the radio 302 is retained within the radio holster 100, the shielding portion 104 may extend upward from a base portion 306 of the radio holster 100 to at least partially conceal the volume knob 304 on the top portion of the radio 302. In some examples, the shielding portion 104 may extend above the volume knob 304, flush with the volume knob 304, or below flush with the volume knob 304. Because the shielding portion 104 extends upward from the base portion 306 in a direction substantially parallel to a longitudinal axis passing through the radio 302 from top to bottom, the shielding portion 104 may conceal one or more side-mounted controls of the radio 302, such as a push-to-talk button.

The retention clip 106 may engage with at least a portion of the radio 302 to retain the radio 302 within the radio holster 100. In some cases, the radio 302 may include an antenna extending from the top portion, and the radio holster 100 may accommodate the antenna by providing an open section to allow unrestricted operation. The shielding portion 104 may be positioned to create a continuous protective structure around the top-mounted controls, reducing the likelihood of inadvertent activation or adjustment while the radio 302 is holstered.

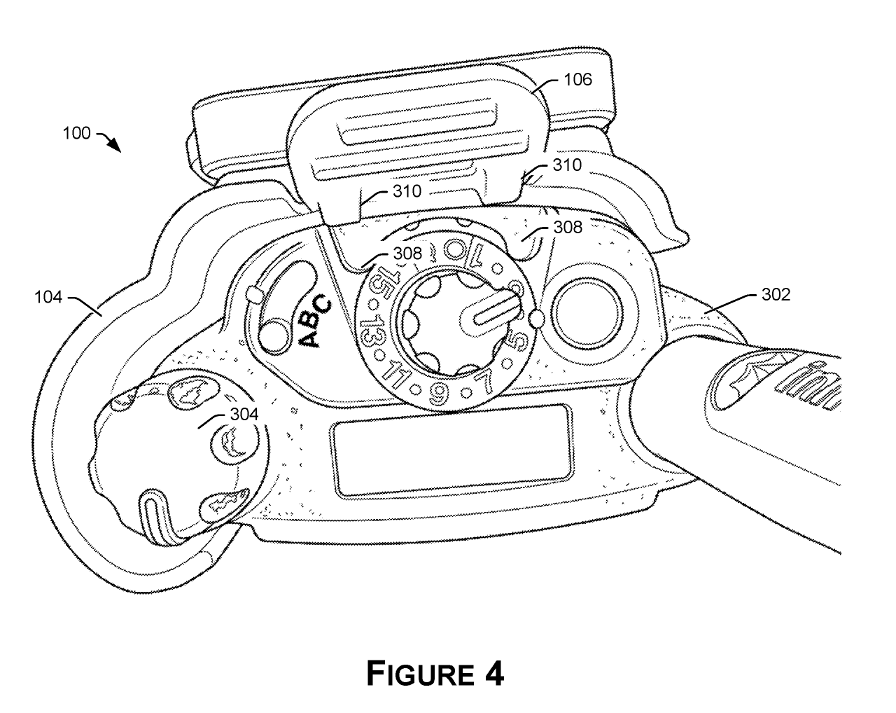

FIG. 4 illustrates a top-down view of the radio holster 100 securing the radio 302, in accordance with some embodiments of the present disclosure. As shown, the shielding portion 104 may extend and protrude upward above a top portion of the radio 302 to protect and prevent unintentional adjustment of the volume knob 304 and other top-mounted controls of the radio 302. The retention clip 106 may be positioned at a top portion of the radio holster 100 and may engage with a portion of the radio 302 to secure the radio 302 within the radio holster 100.

In some examples, the radio 302 may include notches 308 located on the top portion of the radio 302. The retention clip 106 may include tabs 310 that align and engage with the notches 308 to retain the radio 302 within the radio holster 100. The engagement between the tabs 310 and the notches 308 may provide a secure connection that prevents vertical displacement of the radio 302 while still allowing intentional removal.

The shielding portion 104 may form a continuous barrier around the volume knob 304 and other control interfaces to prevent accidental contact while the radio 302 is retained in the radio holster 100. In some cases, the shielding portion 104 may extend along multiple sides of the radio 302 to provide protection for top-mounted controls and side-mounted controls from unintentional interaction.

The body 102, the shielding portion 104, the retention clip 106, and the retention strap 108 may work together to secure the radio 302 within the radio holster 100 while preventing unintentional interaction with control interfaces of the radio 302. The body 102 may receive and retain the radio 302, providing structural support and housing for the radio 302 when holstered. The body 102 may be configured to provide firm engagement with the radio 302 to minimize movement that could otherwise lead to displacement of the radio 302 from the radio holster 100 or unintended adjustment or activation of control interfaces.

The shielding portion 104 may provide physical protection for the volume knob 304 and other control interfaces of the radio 302. When the radio 302 is retained within the radio holster 100, the shielding portion 104 may extend upward from the body 102 to at least partially conceal the volume knob 304 and other top-mounted controls. Because the shielding portion 104 extends in a direction substantially parallel to a longitudinal axis passing through the radio 302 from top to bottom, the shielding portion 104 may also conceal one or more side-mounted controls of the radio 302, such as a push-to-talk button. The shielding portion 104 may form a continuous barrier around the volume knob 304 and other control interfaces to prevent accidental contact while the radio 302 is retained in the radio holster 100.

The retention clip 106 and the retention strap 108 may work together to secure the radio 302 and prevent vertical displacement. The retention clip 106 may be positioned at a top portion of the radio holster 100 and may engage with at least a portion of the radio 302 to retain the radio 302 within the radio holster 100. The retention clip 106 may hold the radio 302 in place within the radio holster 100 and prevent vertical displacement while still allowing intentional removal. The retention strap 108 may extend across a portion of the radio 302 to provide supplemental securing force in addition to the retention clip 106. The combination of the retention clip 106 and the retention strap 108 may reduce the likelihood of the radio 302 becoming dislodged during physical activity, movement, or external impacts.

In some cases, the retention clip 106 and the retention strap 108 may function independently or in combination to achieve different retention level classifications. The radio holster 100 may rely on the fit of the radio 302 within the body 102 for retention when neither the retention clip 106 nor the retention strap 108 is included. When the retention clip 106 is included without the retention strap 108, the retention clip 106 may provide a secondary retention feature in addition to passive retention provided by the body 102. When both the retention clip 106 and the retention strap 108 are included, the radio holster 100 may provide multiple retention mechanisms that may be disengaged before removing the radio 302 from the radio holster 100.

A number of implementations have been described. Nevertheless, it will be understood that various modifications may be made without departing from the spirit and scope of the disclosure. Accordingly, other implementations are within the scope of the following claims.

What is claimed is:

1. A radio holster, comprising:
a body configured to receive and retain a radio, the body having a bottom portion and a back portion;
a shielding portion attached to the body and extending upward from the bottom portion and the back portion of the body in a direction substantially parallel to a longitudinal axis of the radio holster, wherein the shielding portion is positioned to at least partially cover one or more control interfaces of the radio including a volume control knob located on a top portion of the radio, the shielding portion forming a continuous protective structure around top-mounted controls and side-mounted controls of the radio to reduce a likelihood of inadvertent activation or adjustment; and
a retention clip positioned at a top portion of the radio holster and configured to engage with at least a portion of the radio to retain the radio within the radio holster and prevent vertical displacement while allowing intentional removal.

2. The radio holster of claim 1, further comprising a retention strap extending across a front portion of the body to provide an additional layer of retention to secure the radio within the radio holster.

3. The radio holster of claim 1, wherein the retention clip includes tabs configured to align and engage with notches located on the top portion of the radio.

4. The radio holster of claim 1, wherein the shielding portion extends above the volume control knob, forming a barrier that surrounds the volume control knob and prevents accidental contact from above.

5. The radio holster of claim 1, wherein the shielding portion at least partially conceals one or more side-mounted controls of the radio including a push-to-talk button.

6. The radio holster of claim 1, wherein the body includes a cutout positioned to expose a push-to-talk button of the radio while the shielding portion continues to shield other side-mounted controls or top-mounted controls from unintentional contact.

7. A radio holster, comprising:
a body configured to receive and retain a radio; and
a shielding portion extending upward from the body along at least one side of the radio, wherein the shielding portion is positioned to at least partially cover a control interface of the radio to prevent inadvertent adjustment while allowing intentional operation.

8. The radio holster of claim 7, wherein the shielding portion extends in a direction substantially parallel to a longitudinal axis associated with the radio holster.

9. The radio holster of claim 7, wherein the control interface includes a volume control knob located on a top portion of the radio.

10. The radio holster of claim 7, wherein the shielding portion extends along at least one side of the radio to at least partially conceal a push-to-talk button.

11. The radio holster of claim 7, further comprising a retention mechanism configured to secure the radio within the body, the retention mechanism including at least one of a retention clip, a strap, or a latch.

12. The radio holster of claim 7, wherein the body includes at least one selectively positioned cutout to allow controlled access to a control interface of the radio while shielding other control interfaces from unintentional operation.

13. The radio holster of claim 7, wherein the body includes an opening corresponding to a speaker location or a microphone location of the radio to allow audio transmission and reception while the radio is retained in the radio holster.

14. The radio holster of claim 7, wherein the shielding portion extends above a top portion of the radio, forming a continuous barrier around at least one control interface to prevent accidental contact.

15. The radio holster of claim 7, wherein the radio holster is configured to provide a retention level corresponding to a Level 1, Level 2, or Level 3 classification based on an inclusion of passive or active retention mechanisms.

16. The radio holster of claim 7, wherein the radio holster is constructed from at least one of a polymer, a composite, or a metal.

17. A method of securing a radio, the method comprising:
inserting a radio into a body of a radio holster; and
positioning a shielding portion of the radio holster adjacent to a control interface of the radio such that the shielding portion obstructs unintentional contact with the control interface while allowing intentional access to the radio.

18. The method of claim 17, wherein the control interface includes a volume control knob located on a top portion of the radio.

19. The method of claim 17, further comprising engaging a retention mechanism with at least a portion of the radio to secure the radio within the body and prevent vertical displacement.

20. The method of claim 17, wherein the shielding portion extends upward from the body in a direction substantially parallel to a longitudinal axis of the radio to at least partially conceal one or more side-mounted controls of the radio.
